(19) United States
(12) Patent Application Publication
(10) Pub. No.: US 2026/0287244 A1
(43) Pub. Date: Sep. 24, 2026

(54) SLIDING DOOR MECHANISM, DOOR BODY ASSEMBLY AND REFRIGERATION DEVICE

(71) Applicants: HEFEI MIDEA REFRIGERATOR CO., LTD., Hefei (CN); HEFEI HUALING CO., LTD., Hefei (CN); MIDEA GROUP CO., LTD., Foshan (CN)

(72) Inventors: Zhanwei Liu, Hefei (CN); Jun Li, Hefei (CN); Huawei Zhang, Hefei (CN)

(21) Appl. No.: 19/161,230

(22) PCT Filed: Nov. 19, 2024
(86) PCT No.: PCT/CN2024/132878

§ 371 Date: Aug. 30, 2025

(30) Foreign Application Priority Data
Nov. 27, 2023 (CN) 202323218961.3
Jan. 22, 2024 (CN) 202410088590.1
Aug. 26, 2024 (CN) 202411187497.2

(51) Int. Cl. F25D 23/02; F25D 11/00

(52) U.S. Cl. CPC F25D 23/021; F25D 11/00

(57) ABSTRACT

A side-by-side door body assembly for an embedded refrigeration apparatus includes a pair of box doors and a pair of door panels. The box doors are rotatably connected to a refrigeration body configured to be embedded in an accommodating space defined by a mounting body. Each door panel is movably mounted on a corresponding box door and is configured to move in the width direction of the box door. Each door panel comprises a first interference position and a second interference position. When the box doors are in the closed position, a gap δ is formed between the end faces of the door panels on the opening side, and a gap δ′ is formed between the hinge-side end face of each door panel and the corresponding side wall of the accommodating space. The gaps δ and δ′are each greater than respective preset movement distances γ and λ before the interference positions exit the accommodating space.

### CROSS-REFERENCES TO RELATED APPLICATIONS

The present application claims priorities to Chinese Patent Application No. 202323218961.3 filed Nov. 27, 2023, entitled “Refrigerator Hinge,” Chinese Patent Application No. 202410088590.1 filed Jan. 22, 2024, entitled “Door Body Assembly and Refrigeration Device,” and Chinese Patent Application No. 202411187497.2, filed Aug. 26, 2024, entitled “Slide door mechanism, Door Body Assembly, and Refrigeration Device,” all of which are hereby incorporated by reference in their entirety.

### FIELD

The present application relates to the field of household appliances, and in particular to a slide door mechanism, a door body assembly and a refrigeration device.

### BACKGROUND

With the growing demand for integrated home appliances, embedded designs are becoming a trend.

However, in order to achieve a better home integration, it is sometimes necessary to fix and connect door panels at the surface of the box door, and at the same time, higher requirements are placed at the gap between the embedded appliances and the side walls of the cupboard to further improve the home integration. This means that when an appliance is embedded in a cabinet, using existing hinge technology, the door body assembly with the door panel will interfere with the side wall of the installation space in the cupboard during the door opening and closing process, preventing the appliance's door body assembly from opening or closing properly.

### BRIEF SUMMARY

The present application proposes a slide door mechanism, door body assembly, and refrigeration device to address the problem that a door body assembly with a door panel may interfere with the side of the installation space during opening and closing and prevent the appliance's door body assembly from opening or closing properly.

An embodiment of the first aspect of the present application provides a slide door mechanism for a refrigeration device, the refrigeration device includes a box body, a box door, and a door panel, the box door is rotatably connected to the box body and is configured to open or close a storage space within the box body, the door panel is slidably provided at an outer side of the box door, the slide door mechanism includes:
a traction part;
a first pedestal having a first guide rail formed at one side and a second guide rail formed at the other side;
a first slider slidably provided at the first guide rail, a traction part rotatably connected between the box body and the first slider;
a second slider slidably provided at the second guide rail for connection with the door panel; and
a flexible cable with two ends connected to the first slider and the second slider, respectively;
in case that the first slider moves at the first guide rail, the first slider drives, via the flexible cable, the second slider to move at the second guide rail in an opposite direction to drive the door panel to move relative to the width direction of the box door.

According to an embodiment of the present application, the first and second guide rails are provided sequentially along the width direction of the first pedestal, and the first guide rail and the second guide rail are provided parallel to each other in extension direction.

According to an embodiment of the present application, the flexible cable comprises:
a first flexible cable passing over a first end of the first pedestal, two ends of the first flexible cable connected to a first end of the first slider and a first end of the second slider respectively; and
a second flexible cable passing over a second end of the first pedestal, two ends of the second flexible cable connected to a second end of the first slider and a second end of the second slider, respectively.

According to an embodiment of the present application, the flexible cable is one of a steel wire rope, a steel strand, or a hemp rope.

According to an embodiment of the present application, the slide door mechanism further comprises:
a first fixation base connected to the first end of the first pedestal, having a first limit slot formed therein, both ends of the first limit slot docking with the first ends of the first and second guide rails, and a portion of the first flexible cable slidably provided in the first limit slot; and
a second fixation base connected to the second end of the first pedestal, having a second limit slot formed therein, both ends of the second limit slot docking with the second ends of the first and second guide rails, and a portion of the second flexible cable slidably provided in the second limit slot.

According to an embodiment of the present application, a first fixation hole is provided in the first fixation base and/or the second fixation base; and a first waist-shaped hole extending along the width direction of the first pedestal is provided in the first pedestal;
the slide door mechanism further comprises a first adjustment member passing through the first fixation hole and slidably provided in the first waist-shaped hole to adjust the tightness of the first flexible cable and the second flexible cable by adjusting the position of the first adjustment member in the first waist-shaped hole.

According to an embodiment of the present application, a second waist-shaped hole extending along the width direction of the first pedestal is provided in the first fixation base and/or the second fixation base; and a second fixation hole provided in the first pedestal;
the slide door mechanism further comprises a second adjustment member sequentially passing through the second waist-shaped hole and the second fixation hole to be fixed to an external structure to adjust the position of the first fixation base and/or the second fixation base relative to the external structure by adjusting the position of the second adjustment member in the second waist-shaped hole.

According to an embodiment of the present application, a rotatable support bearing is provided in the first limit slot and/or the second limit slot;
a portion of first flexible cable abuts the support bearing in the first limit slot; and/or a portion of the second flexible cable abuts the support bearing in the second limit slot.

According to an embodiment of the present application, the traction part includes a traction rod, a first rotation shaft fixation base and a second rotation shaft fixation base;
the first rotary shaft fixation base is connected to the first slider, the second rotary shaft fixation base is used to be connected to the box body, the first end of the traction rod is rotatably connected to the first rotary shaft fixation base, and the second end of the traction rod is rotatably connected to the second rotary shaft fixation base.

A door body assembly according to an embodiment of the second aspect of the present application provides a door body assembly, includes:
a box door rotatably connected to the box body, and is configured to open or close a storage space of the box body;
a door panel slidably provided at an outer side of the box door; and
the slide door mechanism as described in any of the above items, where the slide door mechanism is provided at the box door, the first slider is used for transmission connection with the box body, and the second slider is connected to the door panel;
during the process of opening or closing the box door, the first slider and the second slider move in opposite directions to drive the door panel to move relative to the box door.

According to an embodiment of the present application, a first connection block is provided at the second slider, and a slot for hanging the door panel is formed at the first connection block.

According to an embodiment of the present application, the door body assembly further includes:
a first driven guide rail mechanism provided at the box door in parallel with the slide door mechanism and includes a second pedestal and a third slider; and
a third guide rail is formed at the second pedestal, the third slider is slidably provided at the third guide rail, a second connection block is provided at the third slider, and a slot for hanging the door panel is formed at the second connection block.

According to an embodiment of the present application, the door body assembly further includes:
a second driven guide rail mechanism provided at the box door in an off-axis manner from the slide door mechanism and includes a third pedestal and a fourth slider;
a fourth guide rail is formed at the third pedestal, the fourth slider is slidably provided at the fourth guide rail, a plurality of third connection blocks are provided at the fourth slider, and slots for hanging the door panel are formed in the third connection blocks.

According to an embodiment of the present application, the slide door mechanism, the first driven guide rail mechanism and the second driven guide rail mechanism are provided along the width direction of the box door, the first driven guide rail mechanism is provided parallel to the slide door mechanism, and the second driven guide rail mechanism is off-axis from the slide door mechanism.

According to an embodiment of the present application, the door body assembly further includes:
a first end cover provided at a first end of the box door, where a first mounting slot is formed in the first end cover, and the slide door mechanism and the first driven guide rail mechanism are provided in the first mounting slot; and
a second end cover provided at a second end of the box door, where a second mounting slot is formed in the first end cover, and the second driven guide rail mechanism is provided in the second mounting slot.

According to an embodiment of the present application, the slide door mechanism, the first driven guide rail mechanism and the second driven guide rail mechanism are all provided along the width direction of the box door, the slide door mechanism and the first driven guide rail mechanism are provided at the top of the box door, and the second driven guide rail mechanism is provided at the bottom of the box door.

According to an embodiment of the present application, the slide door mechanism, the first driven guide rail mechanism and the second driven guide rail mechanism are all provided along the width direction of the box door, the slide door mechanism and the first driven guide rail mechanism are provided at the bottom of the box door, and the second driven guide rail mechanism is provided at the top of the box door.

According to an embodiment of the present application, the door body assembly further includes:
a first primary decorative cover detachably provided at the first end cover and formed with a first notch and a second notch, where an end of the first connection block provided with the slot passes through the first notch, and an end of the second connection block provided with the slot passes through the second notch; and
a second primary decorative cover detachably provided at the second end cover and formed with a third notch, where an end of the third connection block provided with the slot passes through the third notch.

According to an embodiment of the present application, one of the first primary decorative cover and the first end cover is provided with a first protrusion, and the other is provided with a first recess corresponding to the first protrusion, and the first primary decorative cover is detachably connected to the first end cover via the first protrusion and the first recess; and
one of the second primary decorative cover and the second end cover is provided with a second protrusion, and the other is provided with a second recess corresponding to the second protrusion, and the second primary decorative cover is detachably connected to the second end cover via the second protrusion and the second recess.

According to an embodiment of the present application, the door body assembly further includes:
a first secondary decorative cover detachably provided at the first end cover to shield the slide door mechanism and the first driven guide rail mechanism; and
a second secondary decorative cover detachably provided at the second end cover to shield the second driven guide rail mechanism.

According to an embodiment of the present application, one of the first secondary decorative cover and the first end cover is provided with the first protrusion, and the other is provided with the first recess corresponding to the first protrusion, and the first secondary decorative cover is detachably connected to the first end cover via the first protrusion and the first recess; and
one of the second secondary decorative cover and the second end cover is provided with the second protrusion, and the other is provided with the second recess corresponding to the second protrusion, and the second secondary decorative cover is detachably connected to the second end cover via the second protrusion and the second recess.

According to an embodiment of the present application, at least one of the first end cover, the second end cover, the first secondary decorative cover and the second secondary decorative cover is provided with a hand grip slot for the user to open or close the box door.

According to an embodiment of the present application, a first hook is provided at the top of the door panel, and a second hook is provided at the bottom of the door panel, and the length of the second hook is greater than that of the first hook; the first hook and the second hook are configured to be inserted into the corresponding slots.

According to an embodiment of the present application, the door body assembly and the box body are configured to be provided in an installation space formed between a first cupboard body and a second cupboard body; during the process of opening or closing the box door, the slide door mechanism is configured to drive the door panel to move a preset distance at the box door so that the door panel avoids the side walls of the first cupboard body and the second cupboard body;
or, the door body assembly and the box body are used to be provided in a cupboard body; during the opening or closing process of the box door, the slide door mechanism is configured to drive the door panel to move a preset distance at the box door so that the door panel avoids the side wall of the cupboard body.

An embodiment of the third aspect of the present application provides a refrigeration device including:
a box body forming a storage space; and
the door body assembly as described in any of the above items, where the box door is rotatably connected to the box body and configured to open or close the storage space.

According to an embodiment of the present application, the box body is formed with at least two storage spaces, and the door body assemblies are provided in plural, each of the door body assemblies corresponds to one of the storage spaces, to drive the door panel to move relative to any of the box doors during the process of opening or closing the corresponding box door.

According to an embodiment of the present application, the box body is formed with a first storage space and a second storage space, and the door body assembly is provided with two, that is a first door body assembly and a second door body assembly; and
the box door of the first door body assembly is rotatably connected to the box body and configured to open or close the first storage space; the box door of the second door body assembly is rotatably connected to the box body and configured to open or close the second storage space.

The above one or more solutions in the embodiments of the present application have at least one of the following technical effects:

According to the slide door mechanism of the present application, a first guide rail and a second guide rail are provided at both sides of the first pedestal, and a first slider and a second slider are slidably provided at the first guide rail and the second guide rail respectively, the first slider and the second slider can slide synchronously along the guide rails under the transmission of the flexible cable and the sliding directions are opposite, one of the first slider and the second slider is connected to the box door or the box body, and the other is connected to the door panel provided at the outer side of the box door, so that when the box door rotates, the two sliders slide relative to each other to drive the door panel to slide relative to the box door, allowing the door panel to avoid obstacles at either sides during the process of the box door rotating to be opened or closed.

According to the door body assembly of the embodiment of the present application, a slide door mechanism is provided at the box door, the slide door mechanism is respectively connected to the box door and the door panel, so that the door panel is driven to slide relative to the width direction of the box door during the process of the box door rotating relative to the box body to be opened or closed, allowing the door panel to avoid obstacles such as side walls and objects during the closing or opening of the box door.

According to the refrigeration device of the embodiment of the present application, by combining the box door and the door panel, the refrigeration device can avoid interference between the door panel and surrounding objects when opening and closing, greatly improving the convenience of use. This design advantage is particularly evident in cramped kitchen environments. Furthermore, the sliders and guide rails within the slide door mechanism ensure smooth movement of the door panel during opening and closing, extending the refrigerator's service life and stability.

By providing a first connection block at the second sliding block of the slide door mechanism and forming a slot for hanging the door panel at the first connection block, it is convenient for users to disassemble and assemble the door panel and the box door, meeting the user's usage needs in different scenarios.

By providing a driven guide rail mechanism at the box door, the door panel is supported and assisted in sliding, making the sliding of the door panel more stable and smooth.

By providing a second hook and a first hook of different lengths at the top and bottom of the door panel respectively, in case that the door panel is hung at the box door, the first hook at the bottom of the door panel can be engaged with the box door first to preliminarily position the door panel, making it easier to align the second hook with the box door slot later for more convenient installation.

By respectively covering the first end cover and the second end cover at both ends of the box door with the first primary decorative cover and the second primary decorative cover, the slide door mechanism and the driven guide rail mechanism can be shielded, making the box door more aesthetic overall.

Additional aspects and advantages of the present application will be given in part in the description below, and in part will become apparent from the description below, or will be learned through the practice of the present application.

### BRIEF DESCRIPTION OF THE DRAWINGS

In order to clearly illustrate the solutions in the embodiments of the present application or the related art, the accompanying drawings used in the description of the embodiments or the related art are briefly introduced below. It should be noted that the drawings in the following description are only some embodiments of the present application. For those of ordinary skill in the art, other drawings may be obtained based on these drawings without creative effort.

FIG. 1 is a schematic diagram of a refrigeration device with its box door opening outward according to an embodiment of the present application;

FIG. 2 is an exploded view of a refrigeration device according to an embodiment of the present application;

FIG. 3 is a first schematic diagram of a slide door mechanism according to an embodiment of the present application;

FIG. 4 is a second schematic diagram of a slide door mechanism according to an embodiment of the present application;

FIG. 5 is an exploded view of a slide door mechanism according to an embodiment of the present application;

FIG. 6 is a first schematic diagram of a first driven guide rail mechanism according to an embodiment of the present application;

FIG. 7 is a second schematic diagram of a first driven guide rail mechanism according to an embodiment of the present application;

FIG. 8 is a first schematic diagram of a second driven guide rail mechanism according to an embodiment of the present application;

FIG. 9 is a second schematic diagram of a second driven guide rail mechanism according to an embodiment of the present application;

FIG. 10 is a schematic diagram of a door panel according to an embodiment of the present application;

FIG. 11 is a schematic diagram of a first hook and a second hook according to an embodiment of the present application;

FIG. 12 is a schematic diagram of a box door, a first end cover, and a second end cover according to an embodiment of the present application;

FIG. 13 is an assembly diagram of a box door, a first end cover, a second end cover, a slide door mechanism, a driven guide rail mechanism, and a hinge according to an embodiment of the present application;

FIG. 14 is a schematic diagram of a first end cover according to an embodiment of the present application;

FIG. 15 is a schematic diagram of a second end cover according to an embodiment of the present application;

FIG. 16 is a schematic diagram of a box door in case that door panels need to be installed according to an embodiment of the present application;

FIG. 17 is a schematic diagram of a box door in case that no door panels need to be installed according to an embodiment of the present application;

FIG. 18 is a first schematic diagram of a first primary decorative cover according to an embodiment of the present application;

FIG. 19 is a second schematic diagram of a first primary decorative cover according to an embodiment of the present application;

FIG. 20 is a schematic diagram of a first secondary decorative cover according to an embodiment of the present application;

FIG. 21 is a first schematic diagram of a second primary decorative cover according to an embodiment of the present application;

FIG. 22 is a second schematic diagram of a second primary decorative cover according to an embodiment of the present application;

FIG. 23 is a schematic diagram of a second secondary decorative cover according to an embodiment of the present application;

FIG. 24 is a schematic diagram of a third end cover according to an embodiment of the present application;

FIG. 25 is a schematic diagram of a fourth end cover according to an embodiment of the present application;

FIG. 26 is a first schematic diagram of a third primary decorative cover according to an embodiment of the present application;

FIG. 27 is a second schematic diagram of a third primary decorative cover according to an embodiment of the present application;

FIG. 28 is a schematic diagram of a third secondary decorative cover according to an embodiment of the present application;

FIG. 29 is a first schematic diagram of a fourth primary decorative cover according to an embodiment of the present application;

FIG. 30 is a second schematic diagram of a fourth primary decorative cover according to an embodiment of the present application;

FIG. 31 is a schematic diagram of a fourth secondary decorative cover according to an embodiment of the present application.

### REFERENCE NUMERALS

1, box body; 110, first connection hole; 120, first beam body; 121, second connection hole; 130, second beam body; 131, fourth connection hole; 132, third connection hole;

2, Box Door;

210, first end cover; 211, first hinge hole; 212, third mounting slot; 213, first mounting slot; 214, first avoidance opening; 215, second avoidance opening; 216, first mounting hole; 217, first protrusion ridge; 218, third recess; 219, fourth recess;

220, second end cover; 221, first guide rail fixation base; 223, second mounting hole; 224, third mounting hole; 225, second protrusion ridge; 227, third protrusion ridge;
310, third end cover; 311, second guide rail fixation base; 313, eighth protrusion ridge 314, second hinge hole; 315, fourth mounting hole; 316, hand grip slot;
320, fourth end cover; 321, fourth avoidance opening; 322, third avoidance opening; 323, fifth mounting slot; 324, sixth mounting slot; 325, fifth mounting hole; 327, ninth protrusion ridge;
4, first hinge; 5, second hinge; 6, third hinge;

7, slide door mechanism; 701, first fixation base; 702, second fixation base; 703, second adjustment member; 704, first adjustment member; 705, first bearing; 706, flexible cable; 707, first rotary shaft fixation base; 708, pin; 709, traction rod; 710, second rotary shaft fixation base; 711, connector; 712, first connection block; 713, second slider; 714, first slider; 715, third bearing; 716, second bearing; 717, first pedestal;

8, first driven guide rail mechanism; 801, third fixation base; 802, fourth fixation base; 803, fourth adjustment member; 804, third adjustment member; 812, second connection block; 813, third slider; 817, second pedestal;

9, second driven guide rail mechanism; 901, fifth fixation base; 902, third pedestal; 903, fourth slider; 904, sixth fixation base; 905, third connection block;

13, first primary decorative cover; 1301, fifth notch; 1302, fourth notch; 1303, first notch; 1304, second notch; 1305, first snap slot; 1306, second rib; 1307, first rib;

14, second primary decorative cover; 1401, third notch; 1403, fourth protrusion ridge; 1404, sixth protrusion ridge; 1405, second snap slot; 1406, third snap slot; 1407, seventh protrusion ridge; 1408, fifth protrusion ridge;

15, third primary decorative cover; 1501, sixth notch; 1503, fourth snap slot;

16, fourth primary decorative cover; 1601, seventh notch; 1602, eighth notch; 1603, tenth notch; 1604, ninth notch; 1605, sixth snap slot; 1606, fifth snap slot;

17, first secondary decorative cover; 18, second secondary decorative cover; 1801, hand portion; 19, third secondary decorative cover; 20, fourth secondary decorative cover;

21, door panel; 2111, first hook; 2112, second hook.

### DETAILED DESCRIPTION

The following describes the present application in further detail with reference to the accompanying drawings and embodiments. The following embodiments are intended to illustrate the present application and are not intended to limit the scope of the present application.

In the description of the embodiments of the present application, it should be noted that the terms “center,” “longitudinal,” “transverse,” “upper,” “lower,” “front,” “back,” “left,” “right,” “vertical,” “horizontal,” “top,” “bottom”, “inner,” and “outer,” etc., indicating orientations or positional relationships, are based on the orientations or positional relationships shown in the accompanying drawings and are intended solely for ease of description and simplification of the embodiments of the present application. The terms do not indicate or imply that the devices or components referred to must have a specific orientation, be constructed, or operate in a specific orientation, and therefore should not be construed as limiting the embodiments of the present application. In addition, the terms “first,” “second,” and “third” are used for descriptive purposes only and are not intended to indicate or imply relative importance.

In the description of the embodiments of the present application, it should be noted that, unless otherwise expressly specified or limited, the terms “connected” and “connected” should be understood broadly. For example, they can refer to fixed, detachable, or integral connections; mechanical or electrical connections; and direct or indirect connections through an intermediary. Those skilled in the art will understand the specific meanings of the above terms in the embodiments of the present application.

In the embodiments of the present application, unless otherwise specified or limited, a first feature being “above” or “below” a second feature may mean that the first and second features are in direct contact, or that the first and second features are in indirect contact through an intermediary. Also, a first feature being “above,” “above,” or “above” a second feature may mean that the first feature is directly above or diagonally above the second feature, or simply means that the first feature is at a higher level than the second feature. A first feature being “below,” “below,” or “below” a second feature may mean that the first feature is directly below or diagonally below the second feature, or simply means that the first feature is at a lower level than the second feature.

In this specification, the description of the reference terms “an embodiment”, “some embodiments”, “an example”, “specific example”, or “some examples” mean that the specific features, structures, materials or characteristics described in combination with the embodiment or example are included in at least one embodiment or example of the present application. In this specification, the schematic representation of the above terms does not necessarily refer to the same embodiment or example. Moreover, the specific features, structures, materials or characteristics described may be combined in any or more embodiments or examples in a suitable manner. In addition, without contradicting each other, a person skilled in the art may combine different embodiments or examples described in this specification and the features of different embodiments or examples.

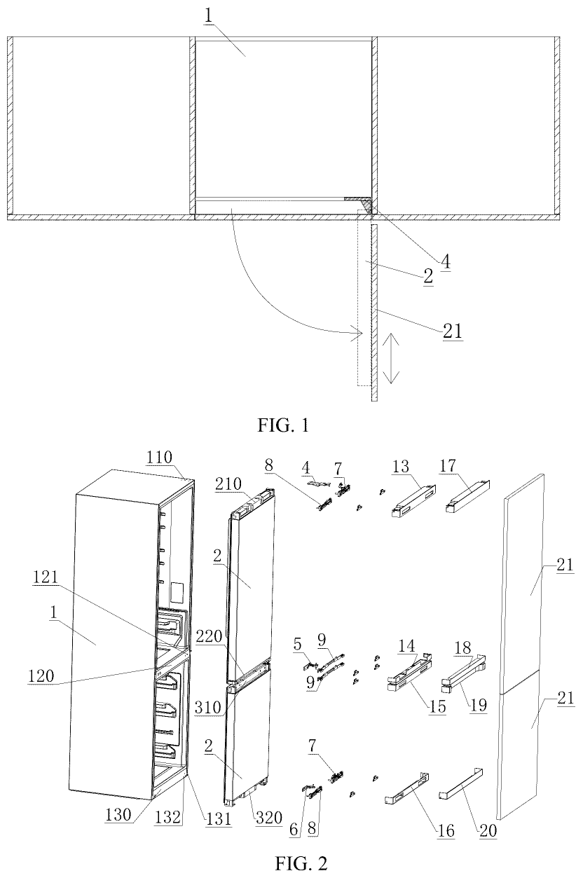

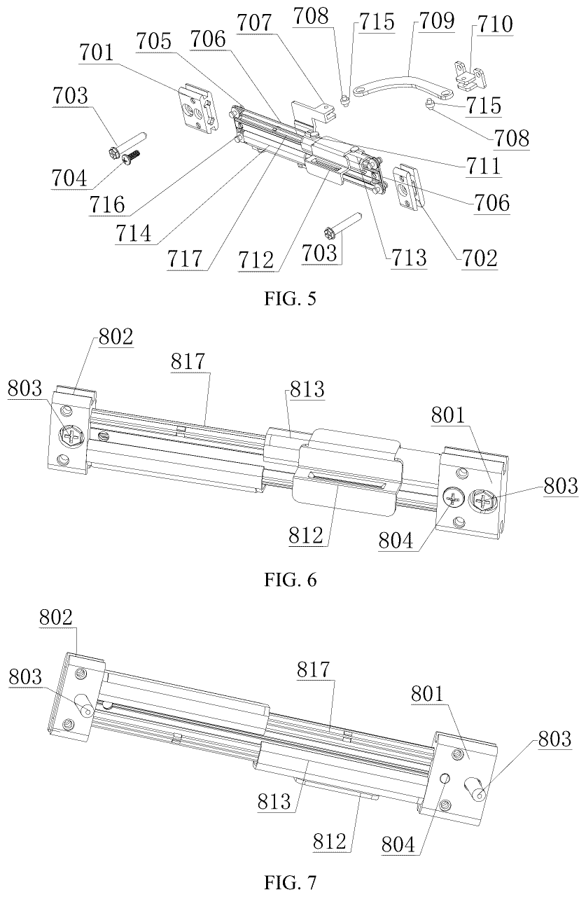

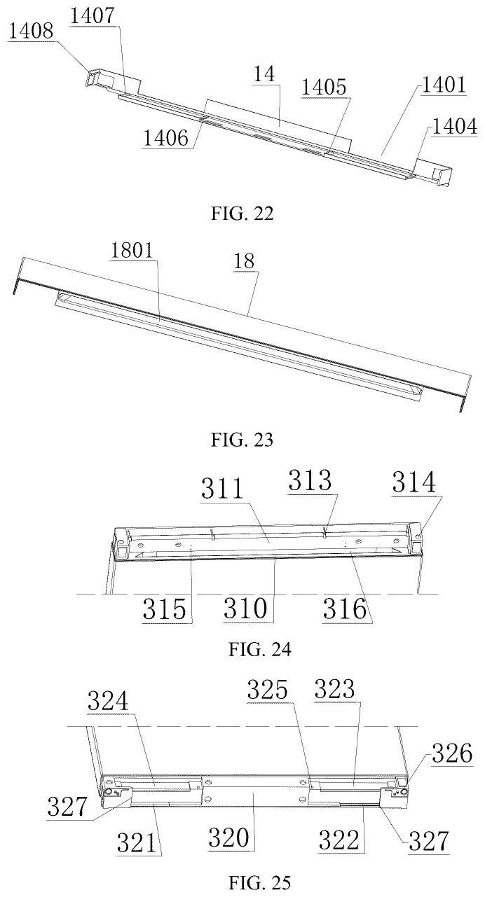

The slide door mechanism, door body assembly, and refrigeration device of the present application are described below with reference to FIGS. 1 to 31. The slide door mechanism and door body assembly described herein can be applied to box doors or cupboard doors of household appliances, such as refrigerator doors. However, it should be understood that the door panel mechanism and door body assembly described herein can also be applied to dishwashers, washing machines, or any other suitable appliance. The refrigeration device described herein is, for example, applied to a refrigerator, but it should be understood that the refrigeration device described herein can also be applied to freezers or any other suitable appliance.

In an embodiment of the present application, as shown in FIGS. 1 to 5, a slide door mechanism 7 is applied to a refrigeration device, the refrigeration device includes a box body 1, a box door 2, and a door panel 21. The box door 2 is rotatably connected to the box body 1 and configured to open or close a storage space within the box body 1. The door panel 21 is slidably provided at an outer side of the box door 2. The slide door mechanism 7 includes a first pedestal 717, a first slider 714, a second slider 713, and a flexible cable 706. The first pedestal 717 has a first guide rail formed at one side and a second guide rail formed at the other side. The first slider 714 is slidably provided at the first guide rail, a traction part rotatably connected between the box body 1 and the first slider 714. The second slider 713 is slidably provided at the second guide rail for connection with the door panel 21. Two ends of the flexible cable 706 are connected to the first slider 714 and the second slider 713, respectively. In case that the first slider 714 moves at the first guide rail, the first slider 714 drives, via the flexible cable 706, the second slider 713 to move at the second guide rail in an opposite direction, thereby driving the door panel 21 to move relative to the width direction of the box door 2.

In some embodiments, the slide door mechanism 7 can be provided at the box door 2, where one of the first slider 714 and the second slider 713 is in transmission connection with the box door 2 or the box body 1, the other is slidably connected to the door panel 21 provided at the outer side of the box door 2. This allows the first slider 714 and the second slider 713 to slide relative to each other when the box door 2 rotates, to drive the door panel 21 to slide relative to the box door 2, allowing the door panel 21 to avoid obstacles at either side during the process of the box door 2 rotating to be opened or closed.

In an embodiment, taking an example of the first slider 714 connected to the box body 1 via a traction part and the second slider 713 connected to the door panel 21, the first pedestal 717 of this embodiment can be provided at the box door 2. Two ends of the flexible cable 706 are connected to the first slider 714 and the second slider 713 respectively, allowing the first slider 714 to pull the second slider 713 through the flexible cable 706 for synchronous movement, thereby driving the door panel 21 to slide relative to the box door 2.

By properly setting the extension direction of the flexible cable 706, the first slider 714 and the second slider 713 move in opposite directions during movement, thereby driving the door panel 21 to avoid obstacles.

For example, when the box door 2 is rotated to be opened outside the box body 1, the box door 2 drives, via the traction part, the first slider 714 to slide toward a first hinge 4, and at the same time, the first slider 714 drives, via the flexible cable 706, the second slider 713 to slide in the opposite direction (i.e., away from the first hinge 4), thereby preventing the door panel 21 from interfering with external obstacles. When the box door 2 is rotated to be closed toward the side of the box body 1, the box body 1 drives the first slider 714 to slide away from the first hinge 4, and at the same time, the first slider 714 drives, via the flexible cable 706, the second slider 713 to slide in the opposite direction (i.e., toward the first hinge 4), thereby preventing the door panel 21 from interfering with obstacles after being closed.

In some embodiments, the first slider 714 can also be connected to the door panel 21. Correspondingly, the second slider 713 is connected to the box door 2 or the box body 1 through a traction part. The process is the same as the above embodiment and will not be repeated here.

According to the slide door mechanism 7 of the present application, a first guide rail and a second guide rail are provided at both sides of the first pedestal 717, and a first slider 714 and a second slider 713 are slidably provided at the first guide rail and the second guide rail respectively, the first slider 714 and the second slider 713 can slide synchronously along the guide rails under the transmission of the flexible cable 706 and the sliding directions are opposite, one of the first slider 714 and the second slider 713 is connected to the box door 2 or the box body 1 through a traction part, and the other is connected to the door panel 21 provided at the outer side of the box door 2, so that when the box door 2 rotates, the two sliders slide relative to each other to drive the door panel 21 to slide relative to the box door 2, allowing the door panel 21 to avoid obstacles at either sides during the process of the box door rotating to be opened or closed.

It should be noted that, in actual applications, the designs of the first slider 714 and the second slider 713 can be flexible and adaptable to different working scenarios and performance requirements. They are not limited to specific shapes, sizes or materials, but can be customized and optimized according to specific needs.

From a material perspective, the first slider 714 and the second slider 713 can be made of materials with high wear resistance, low friction coefficient, and good stability, such as metal alloys, engineering plastics, or special lubricating materials. These materials are selected to improve the durability of the sliders, reduce wear and noise during sliding, and ensure smooth sliding.

In terms of structural design, the first slider 714 and the second slider 713 can utilize various guide rail contact surfaces, such as flat contact, ball contact, or sliding bearing contact. Each of these contact methods has its own advantages and disadvantages. For example, ball contact reduces friction and wear, but is more expensive; flat contact offers a simpler structure but may require more frequent lubrication and maintenance. Therefore, the selection process should comprehensively consider factors such as usage conditions, cost-effectiveness, and ease of maintenance.

Furthermore, to enhance the load-bearing capacity and stability of the sliders, reinforcing ribs, support plates, or other secondary structures may be added to the first slider 714 and the second slider 713. These structures can increase the rigidity and deformation resistance of the sliders, ensuring stable sliding performance when bearing the weight of the door panel 21 and external forces.

In this embodiment, the first guide rail and the second guide rail are provided in sequence along the width direction of the first pedestal 717, and the first guide rail and the second guide rail are provided parallel to the width direction of the first pedestal 717, while ensuring that the length of the first guide rail and the second guide rail can meet the sliding distance of the first slider 714 and the second slider 713, the dimensions of the first pedestal 717 in the height direction and the thickness direction can be effectively reduced, so that the structure is more compact and occupies less space.

In actual applications, due to factors such as machine tool accuracy, tool wear, and material inhomogeneity, errors may occur in the machining of the first guide rail and the second guide rail and the pedestal. These errors may include dimensional errors (such as deviations in length, width, and height), shape errors (such as straightness, flatness, and roundness), and position errors (such as coaxiality, parallelism, and perpendicularity). The parallelism between the first guide rail and the second guide rail is assessed by measuring their relative positional deviation. This deviation must be controlled within a certain tolerance range to ensure smooth sliding of the slider and stable operation of the system. This tolerance range is typically determined based on design requirements, the operating environment, and system accuracy.

It should be noted that in this embodiment, parallelism and verticality should not be strictly defined in a geometric sense. At least the manufacturing and installation errors should be considered, and the error of plus or minus 10° should be understood as within the scope of protection of the patent.

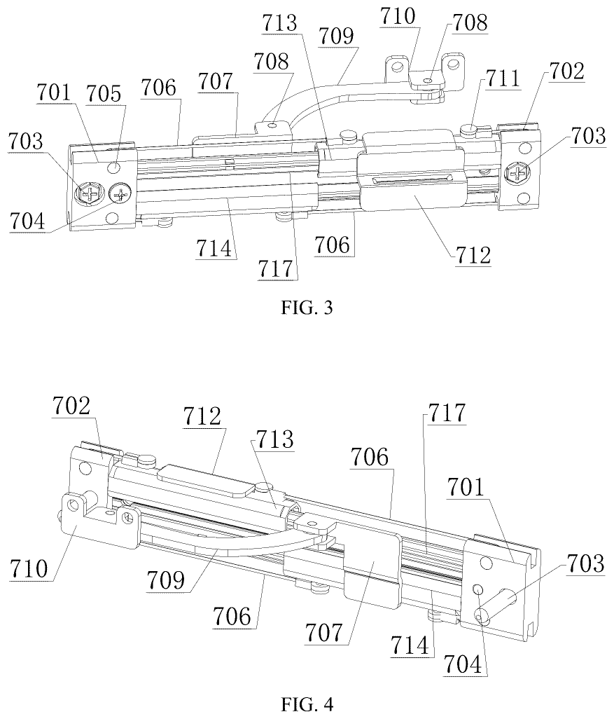

In an embodiment of the present application, as shown in FIGS. 3, 4, and 5, the flexible cable 706 includes a first flexible cable and a second flexible cable. The first flexible cable passes over the first end of the first pedestal 717, and two ends of the first flexible cable are respectively connected to the first ends of the first slider 714 and the second slider 713; the second flexible cable passes over the second end of the first pedestal 717, and two ends of the second flexible cable are respectively connected to the second ends of the first slider 714 and the second slider 713.

In this embodiment, the first flexible cable is respectively connected to the first slider 714 and the second slider 713 by passing the first flexible cable over the first end of the first pedestal 717, when the first slider 714 is driven by the box door 2 or the box body 1 to slide in the direction away from the first end of the first pedestal 717 through the traction part, the first slider 714 drives the second slider 713 to slide in the direction close to the first end of the first pedestal 717 through the first flexible cable, while the second flexible cable is respectively connected to the first slider 714 and the second slider 713 by passing the second flexible cable over the second end of the first pedestal 717, when the first slider 714 slides toward the other end away from the first pedestal 717 under the drive of the box door 2, the first slider 714 drives the second slider 713 to slide toward the other end close to the first pedestal 717 through the second flexible cable, achieving that when the first slider 714 slides toward both ends of the first pedestal 717 respectively, it can drive the second slider 713 and the first slider 714 to slide in the opposite direction, thereby enabling the door panel 21 to slide relative to the box door 2 as the box door 2 rotates when the box door 2 is opened and closed, to avoid interference with obstacles that may affect the opening and closing of the box door 2.

Flexible cable 706 may be one of steel wire rope, steel strand, or hemp rope. The selection depends on the load the flexible cable 706 needs to bear, operating environment, and intended use. For applications requiring heavy loads and harsh environments, steel wire rope or steel strand is recommended; for applications with lighter loads and milder environments, hemp rope can be considered. While meeting the intended use, consider the cost differences between different materials and choose the most cost-effective one. Furthermore, steel wire rope and steel strand may require regular inspection and maintenance during use to ensure performance and safety; hemp rope, on the other hand, is relatively easy to replace and maintain.

In an embodiment, each of the second slider 713 and the first slider 714 is provided with a connector 711 for fixing the flexible cable 706.

In an embodiment of the present application, as shown in FIGS. 3, 4 and 5, the slide door mechanism 7 further includes a first fixation base 701 and a second fixation base 702. The first fixation base 701 is connected to the first end of the first pedestal 717, and is formed with a first limit slot. Both ends of the first limit slot are docked with the first ends of the first guide rail and the second guide rail, and a part of the first flexible cable is slidably provided in the first limit slot. The second fixation seat 702 is connected to the second end of the first pedestal 717, and is formed with a second limit slot. Both ends of the second limit slot are docked with the second ends of the first guide rail and the second guide rail, and a part of the second flexible cable is slidably provided in the second limit slot.

In this embodiment, the first fixation base 701 and the second fixation base 702 are respectively provided at two ends of the first pedestal 717, and the first fixation base 701 and the second fixation base 702 are respectively formed with a first limit slot and a second limit slot docking with the first guide rail and the second guide rail, respectively limiting and guiding the positions of the first flexible cable and the second flexible cable, so that the sliding of the first flexible cable and the second flexible cable is smoother.

In an embodiment, a first fixation hole is provided in the first fixation base 701, and a first waist-shaped hole extending along the width direction of the first pedestal 717 is provided in the first pedestal 717; the slide door mechanism 7 further includes a first adjustment member 704, which passes through the first fixation hole and is slidably provided in the first waist-shaped hole to adjust the tightness of the first flexible cable by adjusting the position of the first adjustment member 704 in the first waist-shaped hole.

In this embodiment, by adjusting the position of the first adjustment member 704 in the first waist-shaped hole, the position of the first fixation base 701 can be adjusted along the width direction of the first pedestal 717, so that the first fixation base 701 can tighten or loosen the first flexible cable, thereby adjusting the tightness of the first flexible cable.

Since the first flexible cable and the second flexible cable are respectively located at the first fixation base 701 and the second fixation base 702 at both sides of the first pedestal 717, and the first flexible cable and the second flexible cable are connected to the first slider 714 and the second slider 713 at both ends, when the first fixation base 701 is adjusted to move relative to the first pedestal 717 through the first waist-shaped hole, the first flexible cable is adjusted in tightness accordingly, and the second flexible cable is also adjusted in tightness accordingly under the pulling of the first fixation base 701 at the first flexible cable.

In some embodiments, a first fixation hole can also be provided in the second fixation base 702; a first waist-shaped hole extending along the width direction of the first pedestal 717 is provided in the first pedestal 717; the slide door mechanism 7 further includes a first adjustment member 704, the first adjustment member 704 passes through the first fixation hole and is slidably provided in the first waist-shaped hole to adjust the tightness of the second flexible cable by adjusting the position of the first adjustment member 704 in the first waist-shaped hole.

In this embodiment, by adjusting the position of the first adjustment member 704 in the first waist-shaped hole, the position of the second fixation base 702 can be adjusted along the width direction of the first pedestal 717, so that the second fixation base 702 can tighten or loosen the second flexible cable, thereby adjusting the tightness of the second flexible cable.

Since the first flexible cable and the second flexible cable are respectively located at the first fixation base 701 and the second fixation base 702 at both sides of the first pedestal 717, and the first flexible cable and the second flexible cable are connected to the first slider 714 and the second slider 713 at both ends, when the second fixation base 702 is adjusted to move relative to the first pedestal 717 through the first waist-shaped hole, the tightness of the second flexible cable is adjusted accordingly, and the tightness of the first flexible cable is also adjusted accordingly under the pulling of the second fixation base 702 at the second flexible cable.

Further, in some embodiments, the first fixation base 701 is provided with a second waist-shaped hole extending along the width direction of the first pedestal 717. The first pedestal 717 is provided with a second fixation hole. The slide door mechanism 7 further includes a second adjustment member 703, the second adjustment member 703 sequentially passes through the second waist-shaped hole and the second fixation hole to be fixed to an external structure, so that the position of the first fixation base 701 relative to the external structure is adjusted by adjusting the position of the second adjustment member 703 in the second waist-shaped hole.

In this embodiment, the second waist-shaped hole is provided in the first fixation base 701, and the second adjustment member 703 sequentially passed through the second waist-shaped hole and the second fixation hole to be fixed to the external structure, so that the first fixation base 701 is fixed to the external structure and the slide door mechanism 7 is fixed to the external structure (e.g., the box door 2). Meanwhile, the second adjustment member 703 can be fine-tuned along the second waist-shaped hole to adjust the position of the first fixation base 701, thereby coordinating the adjustment of the position of the first fixation base 701 relative to the external structure.

In some embodiments, the second fixation base 702 may also be provided with a second waist-shaped hole extending along the width direction of the first pedestal 717; the second adjustment member 703 sequentially passes through the second waist-shaped hole and the second fixation hole to be fixed to the external structure, so that the position of the second fixation base 702 relative to the external structure is adjusted by adjusting the position of the second adjustment member 703 in the second waist-shaped hole. The functions of the second adjustment member 703, the second waist-shaped hole, and the second fixation hole are similar to those in the above embodiment and are not further described here.

Further, in some embodiments, a rotatable support bearing is provided in the first limit slot; a portion of the first flexible cable abuts the support bearing in the first limit slot. In this embodiment, by abutting a portion of the first flexible cable against the support bearing, the movement and extension direction of the first flexible cable can be adjusted, thereby facilitating the first flexible cable to pass over the end of the first pedestal 717 and connect to the first slider 714 and the second slider 713.

In some embodiments, a rotatable support bearing may also be provided in the second limit slot; a portion of the second flexible cable abuts against the support bearing in the second limit slot to adjust the extension direction of the second flexible cable, thereby facilitating the second flexible cable to pass over the end of the first pedestal 717 and connect to the first slider 714 and the second slider 713.

In some embodiments, the support bearing includes a first bearing 705 and a second bearing 716, which are respectively located at an end of the first guide rail and the second guide rail at the same side and respectively located at both sides of the first pedestal 717.

In an embodiment of the present application, as shown in FIGS. 3 to 5, the traction part includes a traction rod 709, a first rotation shaft fixation base 707, and a second rotation shaft fixation base 710. The first rotation shaft fixation base 707 is connected to the first slider 714, and the second rotation shaft fixation base 710 is used to be connected to the box body 1, the first end of the traction rod 709 is rotatably connected to the first rotation shaft fixation base 707, and the second end of the traction rod 709 is rotatably connected to the second rotation shaft fixation base 710.

In this embodiment, the first rotary shaft fixation base 707 and the second rotary shaft fixation base 710 are respectively fixed to the first slider 714 and the box body 1, and the first rotary shaft fixation base 707 and the second rotary shaft fixation base 710 are connected by a traction rod 709, so that the distance between the first slider 714 and the second rotary shaft fixation base 710 remains unchanged. When the box door 2 rotates relative to the box body 1, the angle between the box body 1 and the box door 2 changes, so that the first slider 714 is pulled by the transmission connection of the traction rod 709, the first rotary shaft fixation base 707 and the second rotary shaft fixation base 710, so that the first slider 714 slides at the first pedestal 717, and drives the second slider 713 to slide to realize the movement of the door panel 21 relative to the box door 2.

In an embodiment, an end of the traction rod 709 is rotatably connected to the first rotation shaft fixation base 707 through a pin 708 and a third bearing 715, and the other end is rotatably connected to the second rotation shaft fixation base 710 through another pin 708 and another third bearing 715.

In another embodiment of the present application, as shown in FIGS. 1 and 2, a door body assembly is provided, including a box door 2, a door panel 21, and a slide door mechanism 7 as provided in any of the above embodiments. The box door 2 is rotatably connected to the box body 1 and configured to open or close the storage space of the box body 1. The door panel 21 is slidably provided at the outer side of the box door 2; the slide door mechanism 7 is provided at the box door 2, the first slider 714 is used for transmission connection to the box body 1, and the second slider 713 is connected to the door panel 21. During the process of opening or closing the box door 2, the first slider 714 and the second slider 713 move in opposite directions to drive the door panel 21 to move relative to the box door 2.

In an embodiment, during the process of the box door 2 rotating to be opened outside the box body 1 (as indicated by the curved arrow in FIG. 4) , the box body 1 drives, via the traction part, the first slider 714 to slide toward the first hinge 4, the first slider 714 drives, via the flexible cable 706, the second slider 713 to slide away from the first hinge 4, so that the door panel 21 is driven to slide away from the first hinge 4, thereby preventing the door panel 21 from interfering with external obstacles. Similarly, during the process of the box door 2 rotating to be closed toward the side of the box body 1, the slide door mechanism 7 drives the door panel 21 to slide toward the first hinge 4, thereby preventing the door panel 21 from interfering with obstacles after closing.

According to the door body assembly of the embodiment of the present application, a slide door mechanism 7 is provided at the box door 2, and the slide door mechanism 7 is connected to the box door 2 and the door panel 21, so that when the box door 2 is rotated to be opened or closed relative to the box body 1, the door panel 21 is driven to slide relative to the width direction of the box door 2, allowing the door panel 21 to avoid obstacles such as side walls and objects during the closing or opening process of the box door 2.

In some embodiments, the slide door mechanism 7 has the beneficial effects of the above embodiments, and the door body assembly correspondingly has the beneficial effects of the above embodiments, and the specific implementation of the door body assembly can refer to the above embodiments, and this application will not repeat them.

In an embodiment of the present application, as shown in FIGS. 3 to 5, a first connection block 712 is provided at the second slider 713, and a slot for hanging the door panel 21 is formed in the first connection block 712.

In this embodiment, the first connection block 712 is provided at the second slider 713, and a slot is provided in the first connection block 712, and accordingly, a connection assembly (such as a hook, a plug-in part, etc.) that is adapted to the slot is provided at the door panel 21, so that the door panel 21 is mounted at the first connection block 712, allowing the door panel 21 to slide along the second slider 713. Meanwhile, it is also convenient for users to remove the door panel 21 from the second slider 713 when needed, meeting the user's needs in different scenarios.

In an embodiment of the present application, as shown in FIGS. 2, 6, and 7, the door body assembly further comprises a first driven guide rail mechanism 8. The first driven guide rail mechanism 8 is provided parallel to the slide door mechanism 7 at the box door 2, and includes a second pedestal 817 and a third slider 813. A third guide rail is formed at the second pedestal 817, and the third slider 813 is slidably provided at the third guide rail. The second connection block 812 is provided at the third slider 813, and a slot for hanging the door panel 21 is formed in the second connection block 812.

In this embodiment, the first driven guide rail mechanism 8 is provided parallel to the slide door mechanism 7 at the box door 2, the first driven guide rail mechanism 8 includes the second pedestal 817, at which the third guide rail and the third slider 813 that can slide along the third guide rail are provided, the third slider 813 is connected to the door panel 21 via the second connection block 812. The third slider 813 is capable of sliding with the door panel 21 as the door panel 21 slides relative to the box door 2, thereby supporting and assisting the sliding of the door panel 21 and ensuring that the door panel 21 slide more smoothly relative to the box door 2. Meanwhile, the first driven guide rail mechanism 8 matches with the slide door mechanism 7 to restrict the movement direction of the door panel 21, reducing any shaking of the door panel 21 during sliding and ensuring more stable sliding. Furthermore, the slot in the second connection block 812 can facilitate the user to install the door panel 21 at the driven guide rail mechanism.

The first driven guide rail mechanism 8 further includes a third fixation base 801 and a fourth fixation base 802. The third fixation base 801 and the fourth fixation base 802 are also provided with limit slots similar to those of the first fixation base 701 and the second fixation base 702.

In an embodiment, a third fixation hole is provided in the third fixation base 801, and a third waist-shaped hole extending along the width direction of the second pedestal 817 is provided in the second pedestal 817; the third adjustment member 804 passes through the third fixation hole and is slidably provided in the third waist-shaped hole to adjust the position of the third adjustment member 804 in the third waist-shaped hole.

In some embodiments, a third fixation hole may also be provided in the fourth fixation base 802; a third waist-shaped hole extending along the width direction of the second pedestal 817 is provided in the second pedestal 817; the third adjustment member 804 passes through the third fixation hole and is slidably provided in the third waist-shaped hole to adjust the position of the third adjustment member 804 in the third waist-shaped hole.

Further, the third fixation base 801 is provided with a fourth waist-shaped hole extending along the width direction of the second pedestal 817. The second pedestal 817 is provided with a fourth fixation hole. The fourth adjustment member 803 sequentially passes through the fourth waist-shaped hole and the fourth fixation hole to be fixed to the external structure, so that the position of the third fixation base 801 relative to the external structure is adjusted by adjusting the position of the fourth adjustment member 803 in the fourth waist-shaped hole.

In some embodiments, the fourth fixation base 802 may also be provided with a fourth waist-shaped hole extending along the width direction of the third pedestal 902; the fourth adjustment member 803 sequentially passes through the fourth waist-shaped hole and the fourth fixation hole to be fixed to the external structure, so that the position of the fourth fixation base 802 relative to the external structure is adjusted by adjusting the position of the fourth adjustment member 803 in the fourth waist-shaped hole.

In an embodiment of the present application, as shown in FIGS. 2, 8 and 9, the door body assembly further includes a second driven guide rail mechanism 9, which is provided off-axis from the slide door mechanism 7. The second driven guide rail mechanism 9 includes a third pedestal 902 and a fourth slider 903, a fourth guide rail is formed at the third pedestal 902, and the fourth slider 903 is slidably provided at the fourth guide rail, a plurality of third connection blocks 905 are provided at the fourth slider 903, and a slot for hanging the door panel 21 is formed in the third connection block 905.

In this embodiment, by providing a second driven guide rail mechanism 9, the fourth slider 903 of the second driven guide rail mechanism 9 can slide with the door panel 21 as the door panel 21 slides relative to the box door 2, thereby supporting and assisting the sliding of the door panel 21, and ensuring that the door panel 21 slide more stably and smoothly relative to the box door 2.

Meanwhile, since the second driven guide rail mechanism 9 is provided off-axis from the slide door mechanism 7, the third connection block 905 can cooperate with the slide door mechanism 7 to restrict the movement direction of the door panel 21, thereby preventing the door panel 21 from deflecting around the sliding direction when sliding, and ensuring the sliding process more stable and reliable.

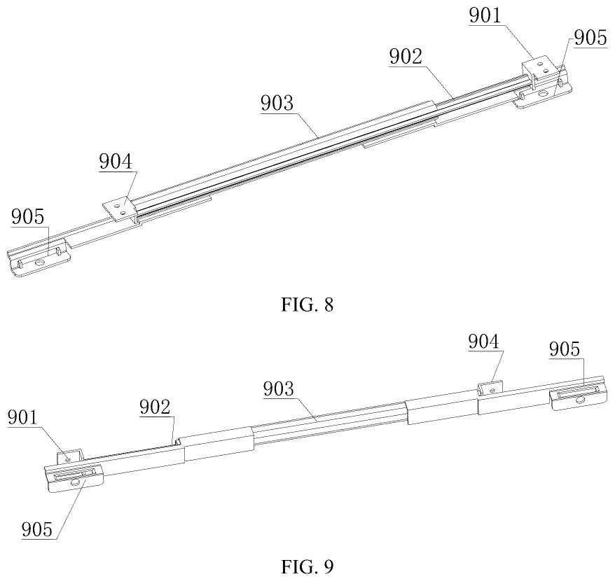

In an embodiment of the present application, as shown in FIGS. 8 and 9, a fifth fixation base 901 and a sixth fixation base 904 are respectively provided at both ends of the third pedestal 902 of the second driven guide rail mechanism 9 for fixed connection with the box door 2.

In an embodiment of the present application, as shown in FIGS. 2 and 6 to 9, the slide door mechanism 7, the first driven guide rail mechanism 8 and the second driven guide rail mechanism 9 are provided along the width direction of the box door 2, the first driven guide rail mechanism 8 and the slide door mechanism 7 are provided in parallel, and the second driven guide rail mechanism 9 is provided off-axis from the slide door mechanism 7.

In some embodiments, the width direction of the box door 2 is parallel to the plane where the box door 2 is located and perpendicular to the rotation axis of the box door 2, so that the door panel 21 can move away from or close to the rotation axis of the box door 2 (as shown by the double-headed arrow in FIG. 4).

In this embodiment, by arranging the first driven guide rail mechanism 8 parallel to the slide door mechanism 7, the third slider 813 can slide parallel to the slide door mechanism 7, effectively assisting the door panel 21 in sliding relative to the box door 2 under the drive of the slide door mechanism 7. Simultaneously, the second connection block 812 cooperates with the slide door mechanism 7 to restrict the movement direction of the door panel 21, preventing the door panel 21 from swinging during movement. Meanwhile, since the second driven guide rail mechanism 9 is provided off-axis from the slide door mechanism 7, the third connection block 905 can cooperate with the slide door mechanism 7 to restrict the movement direction of the door panel 21, thereby preventing the door panel 21 from deflecting around the sliding direction when sliding, and ensuring the sliding process more stable and reliable.

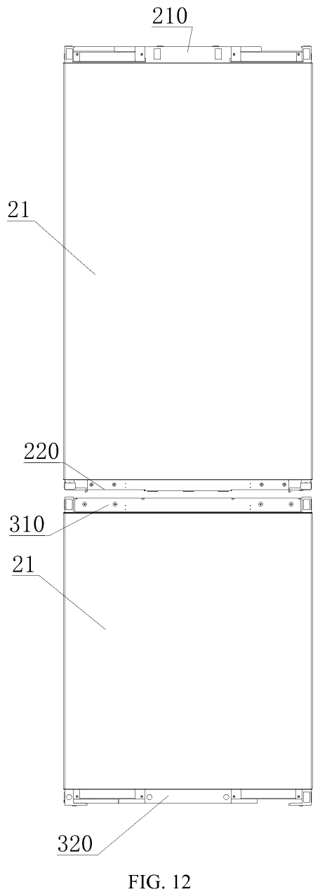

In an embodiment of the present application, as shown in FIGS. 12 to 15, the door body assembly further includes a first end cover 210 and a second end cover 220, the first end cover 210 is provided at the first end of the box door 2, and a first mounting slot 213 is formed in the first end cover 210, and the slide door mechanism 7 and the first driven guide rail mechanism 8 are provided in the first mounting slot 213; the second end cover 220 is provided at the second end of the box door 2, and a second mounting slot is formed in the second end cover 220, and the second driven guide rail mechanism 9 is provided in the second mounting slot.

In this embodiment, by respectively providing a first end cover 210 and a second end cover 220 at both ends of the box door 2, and forming a first mounting slot 213 in the first end cover 210 to install the slide door mechanism 7 and the first driven guide rail mechanism 8, and forming a second mounting slot in the second end cover 220 to install the second driven guide rail mechanism 9, the structure of the slide door mechanism 7, the first driven guide rail mechanism 8, the second driven guide rail mechanism 9 and the box door 2 is made more compact and aesthetic.

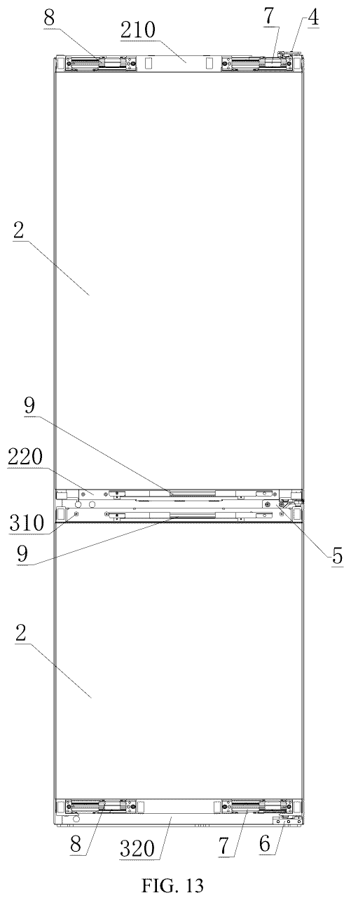

In an embodiment of the present application, as shown in FIG. 13, the first driven guide rail mechanism 8 and the second driven guide rail mechanism 9 are both provided along the width direction of the box door 2, the slide door mechanism 7 and the first driven guide rail mechanism 8 are provided at the top of the box door 2, and the second driven guide rail mechanism 9 is provided at the bottom of the box door 2.

In this embodiment, the slide door mechanism 7 and the first driven guide rail mechanism 8 are provided at the top of the box door 2, and the second driven guide rail mechanism 9 is provided at the bottom of the box door 2, to connect the top of the box door 2 to the door panel 21 through the slide door mechanism 7 and the first driven guide rail mechanism 8, and connect the bottom of the box door 2 to the door panel 21 through the second driven guide rail mechanism 9, thereby ensuring the connection between the door panel 21 and the box door 2 more stable and reliable.

In another embodiment of the present application, the first driven guide rail mechanism 8 and the second driven guide rail mechanism 9 are both provided along the width direction of the box door 2, the slide door mechanism 7 and the first driven guide rail mechanism 8 are provided at the bottom of the corresponding box door 2, and the second driven guide rail mechanism 9 of the first door body assembly is provided at the top of the corresponding box door 2.

In this embodiment, the slide door mechanism 7 and the first driven guide rail mechanism 8 are provided at the bottom of the box door 2, and the second driven guide rail mechanism 9 is provided at the top of the box door 2, to connect the top of the box door 2 to the door panel 21 through the slide door mechanism 7 and the first driven guide rail mechanism 8, and connect the bottom of the box door 2 to the door panel 21 through the second driven guide rail mechanism 9, thereby ensuring the connection between the door panel 21 and the box door 2 more stable and reliable.

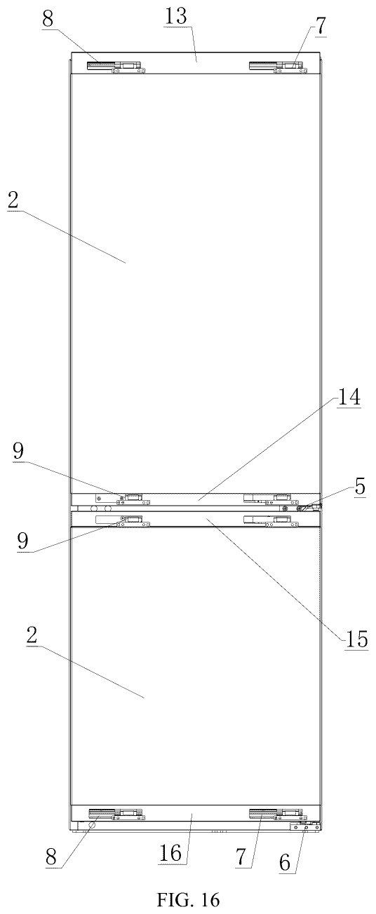

As shown in FIGS. 16, 18, 19, 21, and 22, in an embodiment of the present application, the door body assembly further comprises a first primary decorative cover 13 and a second primary decorative cover 14. The first primary decorative cover 13 is detachably provided at the first end cover 210 and is formed with a first notch 1303 and a second notch 1304. An end of the first connection block 712 having a slot passes through the first notch 1303, and an end of the second connection block 812 having a slot passes through the second notch 1304. The second main decorative cover 14 is detachably provided at the second end cover 220 and is formed with a third notch 1401. An end of the third connection block 905 having a slot passes through the third notch 1401.

In this embodiment, by providing the first primary decorative cover 13 at the box door 2, the first primary decorative cover 13 can cover the entire slide door mechanism 7 and the first driven guide rail mechanism 8, to avoid the slide door mechanism 7 and the first driven guide rail mechanism 8 being completely exposed to the outside, which is more aesthetic; meanwhile, a first notch 1303 and a second notch 1304 are formed in the first primary decorative cover 13, so that the slide door mechanism 7 and the first driven guide rail mechanism 8 can extend to the outside of the first primary decorative cover 13 through the first notch 1303 and the second notch 1304 respectively and connect with the door panel 21, realizing the function of driving the door panel 21 to slide. By detachably providing a second primary decorative cover 14 at the box door 2 to cover the second driven guide rail mechanism 9, the second driven guide rail mechanism 9 is prevented from being exposed to the outside, making the entire box door 2 more aesthetic. The second driven guide rail mechanism 9 passes through the third notch 1401, the second driven guide rail mechanism 9 is used to be connected to the door panel 21 so that the second driven guide rail mechanism 9 cooperates to guide the door panel 21 to move relative to the box door 2 during the process of opening or closing the box door 2.

In some embodiments, the color and material of the first primary decorative cover 13 and the second primary decorative cover 14 of this embodiment can be designed according to user needs and coordinated with the material and color of the outer surface of the box door 2 (for example, remain consistent or coordinate with the outer surface of the box door 2 to form a decorative pattern) to improve the overall aesthetics of the cabinet.

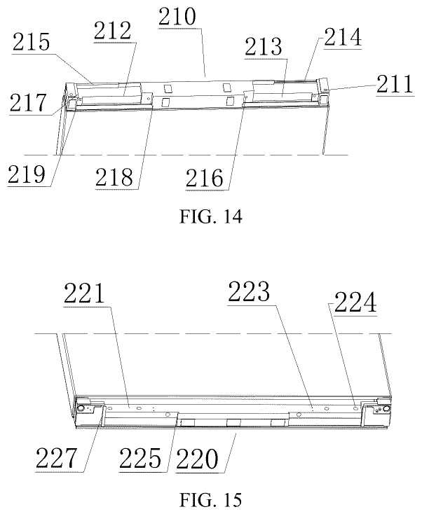

In an embodiment of the present application, as shown in FIGS. 14, 18 and 19, one of the first primary decorative cover 13 and the first end cover 210 is provided with a first protrusion, and the other is provided with a first recess corresponding to the first protrusion, and the first primary decorative cover 13 is detachably connected to the first end cover 210 through the first protrusion and the first recess.

As shown in FIGS. 15, 21 and 22, one of the second primary decorative cover 14 and the second end cover 220 is provided with a second protrusion, and the other is provided with a second recess corresponding to the second protrusion, and the second primary decorative cover 14 is detachably connected to the second end cover 220 through the second protrusion and the second recess.

In this embodiment, the first protrusion is provided at the first end cover 210 and a first recess is provided in the first primary decorative cover 13, the first protrusion and the first recess can be engaged with each other to fix the first primary decorative cover 13 and the first end cover 210 to each other.

In some embodiments, the positions of the first protrusion and the first recess can be interchanged, that is, the first end cover 210 is provided with a first recess, and the first primary decorative cover 13 is provided with a first protrusion.

Similarly, as shown in FIGS. 15, 21 and 22, a second protrusion is provided at the second end cover 220, and a second recess is provided in the second primary decorative cover 14, the second protrusion and the second recess can be engaged with each other to fix the second primary decorative cover 14 and the second end cover 220 to each other.

In some embodiments, the positions of the second protrusion and the second recess can be interchanged, that is, the first recess is provided in the second end cover 220 and the second protrusion is provided at the second primary decorative cover 14.

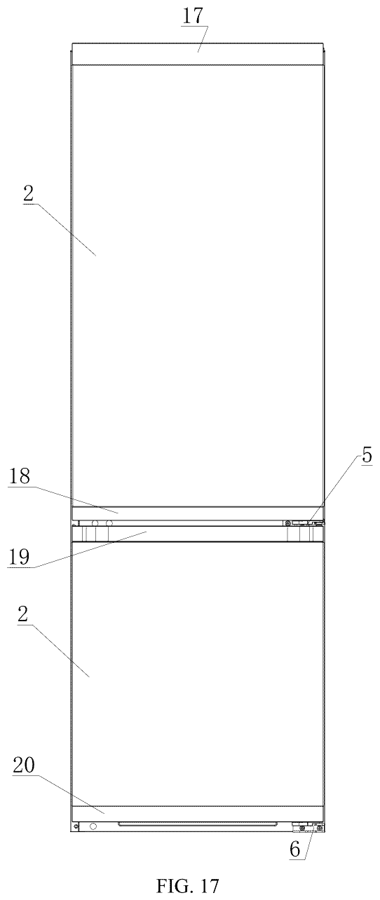

In an embodiment of the present application, as shown in FIGS. 17, 20, and 23, the door body assembly further includes a first secondary decorative cover 17 and a second secondary decorative cover 18. The first secondary decorative cover 17 is detachably provided at the first end cover 210 to shield the slide door mechanism 7 and the first driven guide rail mechanism 8; the second secondary decorative cover 18 is detachably provided at the second end cover 220 to shield the second driven guide rail mechanism 9.

In this embodiment, in some usage scenarios, there is no need to install a door panel 21 at the outer side of the box door 2, the first secondary decorative cover 17 can be used to replace the first primary decorative cover 13 at the first end cover 210, and the second secondary decorative cover 18 can be used to replace the second primary decorative cover 14 at the second end cover 220 respectively, to cover the two driven guide rail mechanisms of the slide door mechanism 7, improving the visual consistency and the aesthetics of the box door 2, and meeting the different usage needs of users.

In an embodiment of the present application, one of the first secondary decorative cover 17 and the first end cover 210 is provided with a first protrusion, and the other is provided with a first recess corresponding to the first protrusion, and the first secondary decorative cover 17 is detachably connected to the first end cover 210 through the first protrusion and the first recess.

One of the second secondary decorative cover 18 and the second end cover 220 is provided with a second protrusion, and the other is provided with a second recess corresponding to the second protrusion, the second secondary decorative cover 18 is detachably connected to the second end cover 220 via the second protrusion and the second recess.

In this embodiment, the first protrusion is provided at the first end cover 210 and the first recess is provided in the first secondary decorative cover 17, the first protrusion and the first recess can be engaged with each other to fix the first secondary decorative cover 17 and the first end cover 210 to each other.

In some embodiments, the positions of the first protrusion and the first recess can be interchanged, that is, the first end cover 210 is provided with a first recess, and the first secondary decorative cover 17 is provided with a first protrusion.

Similarly, a second protrusion is provided at the second end cover 220, and a second recess is provided in the second secondary decorative cover 18, the second protrusion and the second recess can be engaged with each other to fix the second secondary decorative cover 18 and the second end cover 220 to each other.

In some embodiments, the positions of the second protrusion and the second recess can be interchanged, that is, the first recess is provided in the second end cover 220 and the second protrusion is provided at the second secondary decorative cover 18.

In some embodiments, at least one of the first end cover 210, the second end cover 220, the first secondary decorative cover 17, and the second secondary decorative cover 18 is provided with a hand grip slot for a user to open or close the box door 2.

In this embodiment, by providing a hand grip slot in at least one of the first end cover 210, the second end cover 220, the first secondary decorative cover 17 and the second secondary decorative cover 18, it is convenient for users to put their hands into the hand grip slot to manually open or close the box door 2. The structure is simple and the operation is convenient.

In some embodiments, as shown in FIG. 23, in case that there is no need to install the door panel 21, the second driven guide rail mechanism 9 in the second mounting slot can be removed. Accordingly, the second secondary decorative cover 18 is provided with a concave hand portion 1801 at the position corresponding to the second mounting slot, which is convenient for users to manually open and close the box door 2.

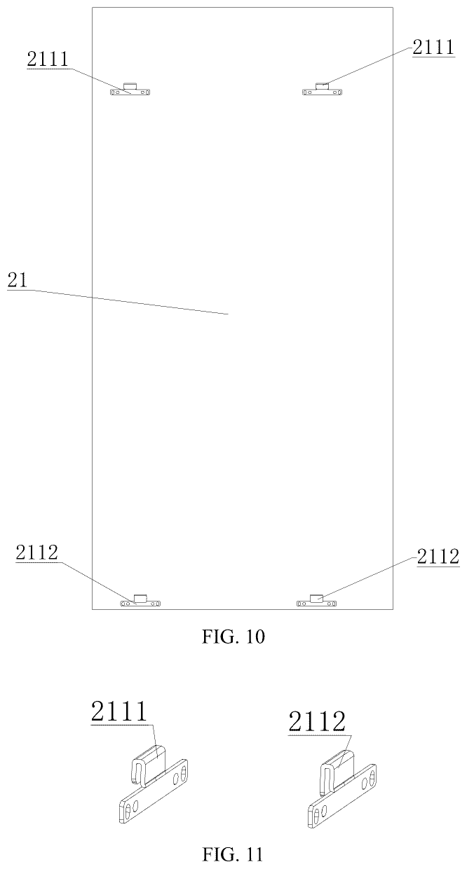

In an embodiment of the present application, as shown in FIGS. 10 and 11, a first hook 2111 is provided at the top of the door panel 21, and a second hook 2112 is provided at the bottom of the door panel 21, the length of the second hook 2112 is greater than that of the first hook 2111. The first hook 2111 and the second hook 2112 are adapted to be inserted into corresponding slots.

In this embodiment, by providing a first hook 2111 and a second hook 2112 at the top and bottom of the door panel 21 respectively, the door panel 21 can be connected to the slots in the slide door mechanism 7 and the two driven guide rail mechanisms via the first hook 2111 and the second hook 2112, thereby slidably connecting the door panel 21 to the cupboard door 2. The first hook 2111 and the second hook 2112 are located at the top and bottom of the door panel 21 respectively, so that the door panel 21 is not easily shaken.

The length of the second hook 2112 is greater than that of the first hook 2111, in case that the door panel 21 is installed at the outer side of the box door 2, the slot at the bottom is first hooked with the second hook 2112 of the door panel 21 to preliminarily position the bottom of the door panel 21. Then, the position and angle of the door panel 21 are adjusted so that the first hook 2111 at the top of the door panel 21 can be inserted into the slot at the top of the box door 2, making it easier for users to align the slot with the first hook 2111 and the second hook 2112 and making installation more convenient.

In an embodiment, the first hook 2111 includes a connecting portion and a hook portion provided at the connecting portion. The hook portion is hook-shaped and is designed to be hooked into a slot. The connecting portion is provided with at least one waist-shaped hole extending horizontally and at least one waist-shaped hole extending vertically. The door panel 21 is provided with a corresponding fixation hole for the first hook 2111. The door panel 21 and the first hook 2111 are fixedly connected by a fixation member that passes through the waist-shaped hole and the fixation hole. By adjusting the position of the fixation member within the waist-shaped hole, the position of the first hook 2111 can be fine-tuned, facilitating installation of the door panel 21 and fine-tuning of the position and angle of the door panel 21.

In some embodiments, the structure of the second hook 2112 is similar to that of the first hook 2111 and is not further described here.

In an embodiment of the present application, as shown in FIG. 2, the door body assembly and the box body 1 are used to be provided in an installation space formed between a first cupboard and a second cabinet; during the opening or closing process of the box door 2, the slide door mechanism 7 is configured to drive the door panel 21 to move a preset distance at the box door 2 so that the door panel 21 avoids the side walls of the first cupboard and the second cabinet.

In this embodiment, the box body 1 is provided between the first cupboard body and the second cupboard body. In some embodiments, the material and color of the door panel 21 can be designed to be similar or the same as the material and color of the outer wall of the cupboard body. When the box door 2 is closed, the door panel 21 is flush with the outer walls of the first cupboard body and the second cupboard body at both sides, so that the door panel 21 and the outer wall of the cupboard body can maintain visual consistency and small gap, which is more aesthetic.

When the box door 2 is rotated outward to be opened, the slide door mechanism 7 drives the door panel 21 to slide a preset distance away from the first hinge 4 to prevent the door panel 21 from interfering with the cupboard wall at the side closest to the first hinge 4, which could prevent the box door 2 from opening to a wider angle. When the box door 2 is rotated to be closed, the slide door mechanism 7 drives the door panel 21 to slide a preset distance toward the first hinge 4 to prevent the door panel 21 from interfering with the cupboard wall at the side away from the first hinge 4, which could prevent the box door 2 from fully closing and affect the function of the box body 1. And when the box door 2 is fully closed, the door panel 21 can return to a flush position with the cabinet. By designing a reasonable preset distance, the door panel 21 can avoid interference with the cupboard walls at both sides when sliding relative to the box door 2.

In another embodiment of the present application, the door body assembly and the box body 1 are used to be provided in a cupboard body; during the opening or closing process of the box door 2, the slide door mechanism 7 is configured to drive the door panel 21 to move a preset distance at the box door 2 so that the door panel 21 avoids the side wall of the cupboard body.

In this embodiment, the box body 1 is provided in a single cupboard body. In some embodiments, the material and color of the door panel 21 can be designed to be similar or the same as the material and color of the outer wall of the cupboard body, and when the box door 2 is closed, the door panel 21 is flush with the outer wall of the cupboard body, so that the door panel 21 and the outer wall of the cupboard body can maintain visual consistency and small gap, which is more aesthetic.

When the box door 2 is rotated outward to be opened, the slide door mechanism 7 drives the door panel 21 to slide a preset distance away from the first hinge 4 to prevent the door panel 21 from interfering with the cupboard wall at the side closest to the first hinge 4, which could prevent the box door 2 from opening to a wider angle. When the box door 2 is rotated to be closed, the slide door mechanism 7 drives the door panel 21 to slide a preset distance toward the first hinge 4 to prevent the door panel 21 from interfering with the cupboard wall at the side away from the first hinge 4, which could prevent the box door 2 from fully closing and affecting the function of the box body 1. And when the box door 2 is fully closed, the door panel 21 can return to a flush position with the cabinet. By designing a reasonable preset distance, the door panel 21 can avoid interference with the cupboard walls at both sides when sliding relative to the box door 2.

In another embodiment of the present application, as shown in FIGS. 1 and 2, a refrigeration device is provided, including: a box body 1 and a door body assembly as provided in any of the above embodiments. The box body 1 is formed with a storage space, and the box door 2 is rotatably connected to the box body 1 and adapted to open or close the storage space.

In this embodiment, the door body assembly includes: a box door 2, a door panel 21 and a slide door mechanism 7. The slide door mechanism 7 is provided at the box door 2 and is configured to drive the door panel 21 to move relative to the width direction of the box door 2 during the process of opening or closing the box door 2.

By providing a door panel 21 at the box door 2, in case that the refrigeration device is embedded and provided in a recess-shaped space, or provided between two cupboard bodies, the door panel 21 can be provided flush with the cupboard bodies at the side walls or both sides of the recess to reduce the gap between the refrigeration device and the adjacent wall or cupboard body, making it more aesthetic.

Meanwhile, when the box door 2 rotates, the slide door mechanism 7 can drive the door panel 21 to move relative to the box door 2 during the rotation of the box door 2 to stay as far away as possible from obstacles such as the wall or cupboard body of the side door of the box body 1, to avoid these obstacles blocking the door panel 21 and affecting the rotation of the box door 2, which could prevent the box door 2 from opening or closing normally.

The combination of the box door 2 and the door panel 21 prevents interference between the door panel 21 and surrounding objects during opening and closing, significantly improving ease of use. This design advantage is particularly evident in cramped kitchen environments. Furthermore, the provision of a slide door mechanism 7 ensures smooth movement of the door panel 21 during opening and closing, extending the lifespan and stability of the refrigerator.

In some embodiments, the door body assembly has the beneficial effects of the above embodiments, and the refrigeration device correspondingly has the beneficial effects of the above embodiments, and the specific implementation of the door body assembly can refer to the above embodiments, and this application will not repeat them.

In an embodiment, the box body 1 can have one or more storage spaces, and each storage space is correspondingly provided with a door body assembly. In some embodiments, the multiple storage spaces can be arranged arbitrarily, such as up and down, left and right, etc.

In some embodiments of the present application, as shown in FIG. 2, the box body 1 is formed with at least two storage spaces, and the door body assemblies are provided in plural, each door body assembly corresponding to one of the storage spaces, to drive the door panel 21 to move relative to the corresponding box door 2 during the opening or closing process of any box door 2.

In the present application, the box body 1 has at least two storage spaces, and the two storage spaces can be set depending on different storage environments (different temperatures, humidity, etc.) to meet the storage requirements of different items. Each storage space is equipped with a corresponding door body assembly, and the box door 2 of the corresponding door body assembly can open or close the corresponding storage space, allowing the two storage spaces to be opened or closed independently, making it convenient for users to store or retrieve items in the storage space. The door panel 21 of each door body assembly can also slide relative to the corresponding box door 2. When the box door 2 is closed, the door panel 21 can be flush with the cupboard body at the side, or when the box door 2 is open, the door panel 21 can avoid obstacles at both sides.

In an embodiment of the present application, as shown in FIG. 2, a box body 1 has a first storage space and a second storage space. Accordingly, the door body assembly also includes a first door body assembly and a second door body assembly. The box door 2 of the first door body assembly is rotatably connected to the box body 1 to open or close the first storage space, and the box door 2 of the second door body assembly is rotatably connected to the box body 1 to open or close the second storage space.

The first door body assembly and the second door body assembly are provided vertically along the height direction of the box door 2. The first door body assembly further includes a first driven guide rail mechanism 8 and a second driven guide rail mechanism 9, and the second door body assembly further includes a first driven guide rail mechanism 8 and a second driven guide rail mechanism 9. The slide door mechanism 7 and the first driven guide rail mechanism 8 of the first door body assembly are provided at the top of the corresponding box door 2, and the second driven guide rail mechanism 9 of the first door body assembly is provided at the bottom of the corresponding box door 2; the slide door mechanism 7 and the first driven guide rail mechanism 8 of the second door body assembly are provided at the bottom of the corresponding box door 2, and the second driven guide rail mechanism 9 of the first door body assembly is provided at the top of the corresponding box door 2.

In an embodiment, as shown in FIG. 2, a first connection hole 110 is provided in the box body 1, the first hinge 4 is connected to the first connection hole 110 of the box body 1, and the box body 1 is rotatably connected to the box door 2 of the first door body assembly through the first hinge 4.

The first storage space and the second storage space are separated by a first beam body 120, the first beam body 120 is provided with a second connection hole 121, and the first beam body 120 is connected to the second hinge 5 via the second connection hole 121. The second hinge 5 has two hinge shafts arranged up and down, and the two hinge shafts are rotatably connected to the box door 2 of the first door body assembly and the box door 2 of the second door body assembly, respectively.

A second beam body 130 is provided at the bottom of the second storage space. A third connection hole 132 and a fourth connection hole 131 are provided in the second beam body 130. The second beam body 130 passes through the third connection hole 132 and the third hinge 6, and is rotatably connected to the box door 2 of the second door body assembly via the third hinge 6. The second beam body 130 is connected to the slide door mechanism 7 of the second door body assembly via the fourth connection hole 131.

The top and bottom of the box door 2 of the first door body assembly are respectively provided with a first end cover 210 and a second end cover 220. The first end cover 210 is rotatably connected to the first hinge 4, and the second end cover 220 is rotatably connected to the hinge shaft of the second hinge 5 at the upper side, so that the box door 2 of the first door body assembly can rotate relative to the box body 1.

The top and bottom of the box door 2 of the second door body assembly are respectively provided with a third end cover 310 and a fourth end cover 320. The fourth end cover 320 is rotatably connected to the third hinge 6, and the third end cover 310 is rotatably connected to the hinge shaft located at the lower side of the second hinge 5, so that the box door 2 of the second door body assembly can rotate relative to the box body 1.

In an embodiment of the present application, as shown in FIGS. 2 and 14, both ends of the first end cover 210 have first hinge holes 211 that are rotatably connected to the first hinge 4. The first end cover 210 can be connected to the first hinge 4 through the first hinge hole 211 at one end. A first mounting slot 213 is provided in the first end cover 210, and a first mounting hole 216 is provided in the slot wall of the first mounting slot 213. The slide door mechanism 7 is fixed by bolts through the first mounting hole 216 and the slot wall of the first mounting slot 213. The first mounting slot 213 is provided with a first avoidance opening 214 at the slot wall facing the box body 1, corresponding to the traction part of the slide door mechanism 7. The traction part of the slide door mechanism 7 can be movably inserted into the first avoidance opening 214 to move with the box door 2 to pull the slide door mechanism 7.

The first end cover 210 is further provided with a third mounting slot 212, into which the first driven guide rail mechanism 8 is mounted. In some embodiments, the positions of the slide door mechanism 7 and the first driven guide rail mechanism 8 can be exchanged according to the hinge position of the box door 2 and the box body 1. Accordingly, a second avoidance opening 215 is also provided in the slot wall of the third mounting slot 212 facing the box body 1 to allow for the traction part of the slide door mechanism 7 to be avoided.

A third recess 218 and a fourth recess 219 and a first protrusion ridge 217 for insertion are provided at the slot walls at opposite sides of the first mounting slot 213 and the third mounting slot 212 to be engaged and fixed with the first primary decorative cover 13 or the first secondary decorative cover 17.

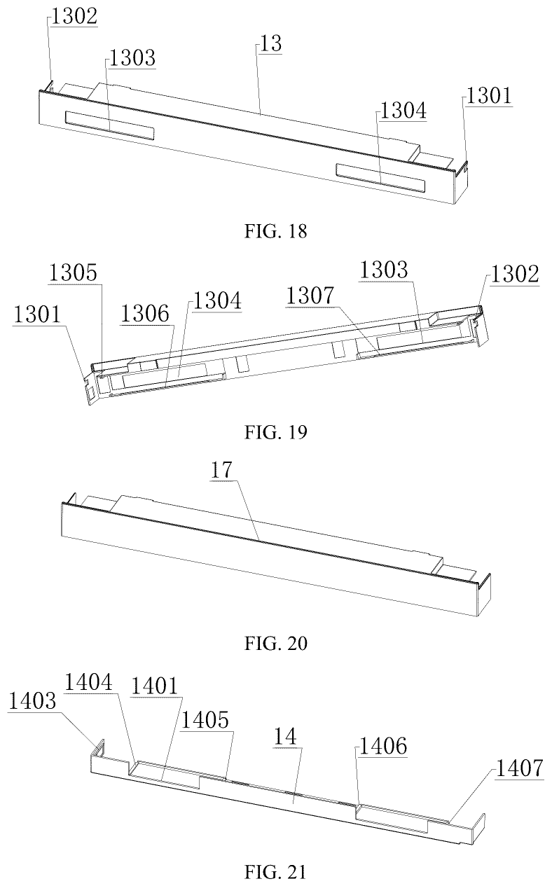

As shown in FIGS. 18 and 19, both side surfaces of the first primary decorative cover 13 are provided with a first notch 1303 and a second notch 1304 corresponding to the first mounting slot 213 and the third mounting slot 212 respectively, allowing the slide door mechanism 7 and the first driven guide rail mechanism 8 to extend out of the notches and be connected to the door panel 21. A fourth notch 1302 and a fifth notch 1301 are provided at each end of the first primary decorative cover 13, allowing the traction part of the slide door mechanism 7 to swing with the movement of the box door 2 when the slide door mechanism 7 is installed in the first mounting slot 213 or the third mounting 212. The first primary decorative cover 13 is provided with a first snap slot 1305 corresponding to the first protrusion ridge 217. The inside of the first notch 1303 is provided with a first rib 1307 for engaging with the slot wall of the first mounting slot 213. The inside of the second notch 1304 is provided with a second rib 1306 for engaging with the slot wall of the third mounting slot 212.

The structure of the first secondary decorative cover 17 is similar to that of the first primary decorative cover 13, but no notch is provided for the slide door mechanism 7 and the first driven guide rail mechanism 8 to extend out, which will not be described in detail here.

As shown in FIG. 15, a third mounting hole 224 is provided in the inner slot wall of the second mounting slot of the second end cover 220, the first guide rail fixation base 221 is installed in the second mounting slot through the third mounting hole 224, a second mounting hole 223 is provided in the first guide rail fixation base 221, and the second driven guide rail mechanism 9 is installed at the first guide rail fixation base 221 through the second mounting hole 223.

In an embodiment, a second protrusion ridge 225 and a third protrusion ridge 227 for insertion are provided at the slot walls at opposite sides of the second mounting slot to be engaged and fixed to the second primary decorative cover 14 or the first secondary decorative cover 17.

In an embodiment of the present application, as shown in FIGS. 8, 9, 21 and 22, there are two third connection blocks 905, and two third notches 1401 are provided in two third connection blocks 905 of the second primary decorative cover 14 corresponding to the second driven guide rail mechanism 9. A cavity for covering the second end cover 220 is formed in the second primary decorative cover 14, and a fourth protrusion ridge 1403 and a fifth protrusion ridge 1408 are provided at both ends of the cavity, and a sixth protrusion ridge 1404 and a seventh protrusion ridge 1407 are provided at the bottom of the cavity, to match with the third protrusion ridge 227 at the second end cover 220; meanwhile, the bottom of the cavity is also provided with a second snap slot 1405 and a third snap slot 1406 that engage with the second protrusion ridge 225, to assemble the second end cover 220 and the second primary decorative cover 14 together.

As shown in FIGS. 2, 12 and 13, the top and bottom of the box door 2 of the second door body assembly are respectively provided with a third end cover 310 and a fourth end cover 320. The fourth end cover 320 is rotatably connected to the third hinge 6, and the third end cover 310 is rotatably connected to the hinge shaft located at the lower side of the second hinge 5, so that the box door 2 of the second door body assembly can rotate relative to the box body 1.

As shown in FIGS. 2, 16 and 17, the second door body assembly further includes a third primary decorative cover 15, a fourth primary decorative cover 16, a third secondary decorative cover 19 and a fourth secondary decorative cover 20.

The third primary decorative cover 15 and the third secondary decorative cover 19 are configured to be detachably mounted at the third end cover 310 at the top of the second door body assembly. In some embodiments, the structure of the third primary decorative cover 15 is similar to that of the second primary decorative cover 14; the structure of the third secondary decorative cover 19 is similar to that of the second secondary decorative cover 18.

The fourth primary decorative cover 16 and the fourth secondary decorative cover 20 are configured to be detachably mounted at the fourth end cover 320 at the bottom of the second door body assembly. In some embodiments, the structure of the fourth primary decorative cover 16 is similar to that of the first primary decorative cover 13; the structure of the fourth secondary decorative cover 20 is similar to that of the first secondary decorative cover 17.

In an embodiment, in case that the door panel 21 of the second door body assembly needs to be installed, the third primary decorative cover 15 and the fourth primary decorative cover 16 can be installed at the third end cover 310 and the fourth end cover 320 respectively; in case that the door panel 21 does not need to be installed, the third primary decorative cover 15 and the fourth primary decorative cover 16 can be removed, and the third secondary decorative cover 19 and the fourth primary decorative cover 16 can be installed at the third end cover 310 and the fourth end cover 320 respectively.

In an embodiment, as shown in FIG. 24, both ends of the third end cover 310 have second hinge holes 314 rotatably connected to the second hinge 5, and the side of the third end cover 310 facing away from the box door 2 has a hand grip slot 316. The third end cover 310 has a fourth mounting slot, into which a second guide rail mount 311 is mounted. The second guide rail mount 311 is provided with a fourth mounting hole 315, through which the second driven guide rail mechanism 9 of the second door body assembly is mounted. The top surface of the third end cover 310 has a plurality of eighth protrusion ridges 313 that engage with the third primary decorative cover 15 and the third secondary decorative cover 19.

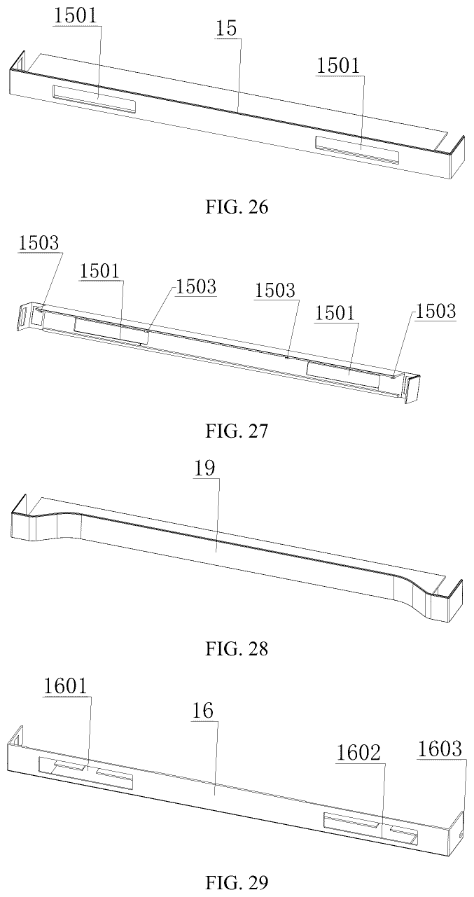

Accordingly, as shown in FIGS. 26 and 27, the third primary decorative cover 15 is provided with two sixth notches 1501 corresponding to the second driven rail mechanism 9 and a plurality of fourth snap slots 1503 corresponding to the eighth protrusion ridges 313. When the third primary decorative cover 15 is engaged with the third end cover 310, the hand grip slot 316 of the third end cover 310 is exposed, allowing the user to conveniently insert their hand into the hand grip slot 316 to open and close the box door 2. The second driven rail mechanism 9 is connected to the door panel 21 via the sixth notches 1501.

As shown in FIG. 28, the structure of the third secondary decorative cover 19 is similar to that of the third primary decorative cover 15, but there is no need to provide a notch structure for the second driven guide rail mechanism 9 to pass through.

As shown in FIG. 25, the fourth end cover 320 is provided with a fifth mounting slot 323, and a fifth mounting hole 325 is provided in the slot wall of the fifth mounting slot 323. The slide door mechanism 7 is fixed by bolts through the fifth mounting hole 325 and the fifth mounting slot 323. The fifth mounting slot 323 is provided with a third avoidance opening 322 at the slot wall facing the box body 1, corresponding to the traction part of the slide door mechanism 7. The traction part of the slide door mechanism 7 can be movably inserted into the third avoidance opening 322 to move with the box door 2 to pull the slide door mechanism 7.

Meanwhile, the fourth end cover 320 is also provided with a sixth mounting slot 324, into which the second driven guide rail mechanism 9 is mounted. In some embodiments, the positions of the slide door mechanism 7 and the first driven guide rail mechanism 8 can be exchanged according to the hinge position of the box door 2 and the box body 1. Accordingly, a fourth avoidance opening 321 is provided in the slot wall of the sixth mounting slot 324 facing the box body 1 to allow for the traction part of the slide door mechanism 7 to be avoided. The fourth end cover 320 is also provided with a ninth protrusion ridge 327 for engaging with the fourth primary decorative cover 16 and the fourth secondary decorative cover 20.

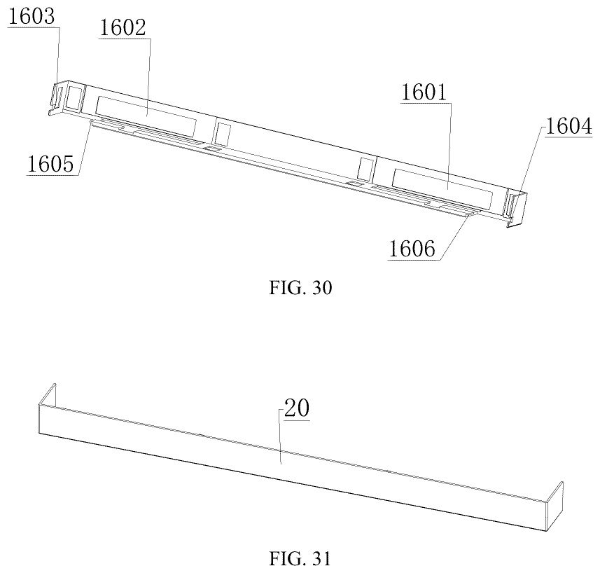

Accordingly, as shown in FIGS. 29 and 30, both side surfaces of the fourth primary decorative cover 16 are provided with a seventh notch 1601 and an eighth notch 1602 corresponding to the fifth and sixth mounting slots 323 and 324, respectively, allowing the slide door mechanism 7 and the first driven guide rail mechanism 8 to extend out of the notches and connect with the door panel 21. A ninth notch 1604 and a tenth notch 1603 are provided at both ends of the fourth primary decorative cover 16, allowing the traction part of the slide door mechanism 7 to swing with the movement of the refrigerator door 2 when the slide door mechanism 7 is installed in the fifth mounting slot 323 and the sixth mounting slot 324, respectively. A fifth snap slot 1606 and a sixth snap slot 1605 are provided in the fourth primary decorative cover 16, corresponding to the ninth protrusion ridge 327.

As shown in FIG. 31, the structure of the fourth secondary decorative cover 20 is similar to that of the fourth primary decorative cover 16, but there is no need to provide a notch structure for the slide door mechanism 7 and the first driven guide rail mechanism 8 to pass through.

Finally, it should be noted that the above embodiments are intended only to illustrate the present application and are not intended to limit the present application. Although the present application has been described in detail with reference to the embodiments, those skilled in the art will appreciate that various combinations, modifications, or equivalent substitutions of the solutions of the present application do not depart from the spirit and scope of the solutions of the present application and are intended to be fall within the scope of the claims of the present application.

1. A slide door mechanism, used for a refrigeration device comprising a box body, a box door and a door panel, the box door being rotatably connected to the box body and configured to open or close a storage space of the box body the door panel being slidably provided at an outer side of the box door, and the slide door mechanism comprising:
a traction part;
a first pedestal having a first guide rail formed at one side and a second guide rail formed at other side;
a first slider slidably provided at the first guide rail, the traction part being rotatably connected between the box body and the first slider;
a second slider slidably provided at the second guide rail for connection with the door panel; and
a flexible cable with two ends connected to the first slider and the second slider, respectively; and
in case that the first slider moves at the first guide rail, the first slider drives, via the flexible cable, the second slider to move at the second guide rail in an opposite direction to drive the door panel to move relative to a width direction of the box door.

2. The slide door mechanism of claim 1, wherein the first guide rail and the second guide rail are sequentially provided along a width direction of the first pedestal, and the first guide rail and the second guide rail are provided parallel to each other in an extension direction.

3. The slide door mechanism of claim 1, wherein the flexible cable comprises:
a first flexible cable passing over a first end of the first pedestal, two ends of the first flexible cable being connected to a first end of the first slider and a first end of the second slider, respectively; and
a second flexible cable passing over a second end of the first pedestal, two ends of the second flexible cable connected to a second end of the first slider and a second end of the second slider, respectively.

4. The slide door mechanism of claim 2, wherein the flexible cable is one of a steel wire rope, a steel strand, or a hemp rope.

5. The slide door mechanism of claim 3, wherein the slide door mechanism further comprises:
a first fixation base connected to the first end of the first pedestal formed with a first limit slot, two ends of the first limit slot docking with a first end of the first guide rail and a first end of the second guide rail respectively, and a portion of the first flexible cable being slidably provided in the first limit slot; and
a second fixation base connected to the second end of the first pedestal formed with a second limit slot, two ends of the second limit slot docking with a second end of the first guide rail and a second end of the second guide rail respectively, and a portion of the second flexible cable being slidably provided in the second limit slot.

6. The slide door mechanism of claim 5, wherein a first fixation hole is provided in the first fixation base and/or the second fixation base, a first waist-shaped hole extending along a width direction of the first pedestal is provided in the first pedestal; and
the slide door mechanism-further comprises a first adjustment member passing through the first fixation hole and slidably provided in the first waist-shaped hole to adjust tightness of the first flexible cable and the second flexible cable by adjusting a position of the first adjustment member in the first waist-shaped hole.

7. The slide door mechanism (7) of claim 6, wherein a second waist-shaped hole extending along the width direction of the first pedestal is provided in the first fixation base and/or the second fixation base, a second fixation hole provided in the first pedestal; and
the slide door mechanism further comprises a second adjustment member sequentially passing through the second waist-shaped hole and the second fixation hole to be fixed to an external structure to adjust a position of the first fixation base and/or the second fixation base relative to the external structure by adjusting a position of the second adjustment member in the second waist-shaped hole.

8. The slide door mechanism of claim 5, wherein a rotatable support bearing is provided in the first limit slot and/or the second limit slot; and
a portion of the first flexible cable abuts the support bearing in the first limit slot, and/or a portion of the second flexible cable abuts the support bearing in the second limit slot.

9. The slide door mechanism of claim 1, wherein the traction part comprises a traction rod, a first rotation shaft fixation base and a second rotation shaft fixation base;
the first rotation shaft fixation base is connected to the first slider, the second rotation shaft fixation base is used to be connected to the box body, a first end of the traction rod is rotatably connected to the first rotation shaft fixation base, and a second end of the traction rod is rotatably connected to the second rotation shaft fixation base.

10. A door body assembly, comprising:
a box door rotatably connected to a box body of a refrigeration device, and configured to open or close a storage space of the box body;
a door panel slidably provided at an outer side of the box door;
the slide door mechanism of claim 1, the slide door mechanism being provided at the box door, the first slider being used for transmission connection to the box body, and the second slider being connected to the door panel; and
during a process of opening or closing the box door, the first slider and the second slider move in opposite directions to drive the door panel to move relative to the box door.

11. The door body assembly of claim 10, wherein a first connection block is provided at the second slider, and a slot for hanging the door panel is formed in the first connection block.

12. The door body assembly of claim 11, wherein the door body assembly further comprises:
a first driven guide rail mechanism provided at the box door in parallel with the slide door mechanism, and comprising a second pedestal and a third slider; and
a third guide rail is formed at the second pedestal, the third slider is slidably provided at the third guide rail, a second connection block is provided at the third slider, and a slot for hanging the door panel is formed in the second connection block.

13. The door body assembly of claim 12, wherein the door body assembly further comprises:
a second driven guide rail mechanism provided at the box door an off-axis manner from the slide door mechanism and comprising a third pedestal and a fourth slider
a fourth guide rail is formed at the third pedestal, the fourth slider is slidably provided at the fourth guide rail, a plurality of third connection blocks are provided at the fourth slider and slots for hanging the door panel are formed in the third connection blocks.

14. The door body assembly of claim 13, wherein the slide door mechanism, the first driven guide rail mechanism and the second driven guide rail mechanism are provided along the width direction of the box door, the first driven guide rail mechanism is provided parallel to the slide door mechanism and the second driven guide rail mechanism is off-axis from the slide door mechanism, wherein
the slide door mechanism, the first driven guide rail mechanism the second driven guide rail mechanism are all provided along the width direction of the box door, the slide door mechanism and the first driven guide rail mechanism are provided at top of the box door, and the second driven guide rail mechanism is provided at bottom of the box door, and/or
the slide door mechanism, the first driven guide rail mechanism and the second driven guide rail mechanism are all provided along the width direction of the box door, the slide door mechanism and the first driven guide ail mechanism are provided at bottom of the box door, and the second driven guide rail mechanism is provided at top of the box door.

15. The door body assembly of claim 13, wherein the door body assembly further comprises:
a first end cover provided at a first end of the box door, a first mounting slot being formed in the first end cover, and the slide door mechanism and the first driven guide rail mechanism; being provided in the first mounting slot; and
a second end cover provided at a second end of the box door, a second mounting slot being formed in the first end cover, and the second driven guide rail mechanism being provided in the second mounting slot, wherein the door body assembly further comprises:
a first primary decorative cover detachably provided at the first end cover and formed with a first notch and a second notch, an end of the first connection block provided with the slot passing through the first notch, and an end of the second connection block provided with the slot passing through the second notch; and
a second primary decorative cover detachably provided at the second end cover and formed with a third notch, an end of the third connection block provided with the slot passing through the third notch.

16-18. (canceled)

19. The door body assembly of claim 1, wherein one of the first primary decorative cover and the first end cover is provided with a first protrusion, and other one is provided with a first recess corresponding to the first protrusion, and the first primary decorative cover is detachably connected to the first end cover via the first protrusion and the first recess; and
one of the second primary decorative cover and the second end cover is provided with a second protrusion, and other one is provided with a second recess corresponding to the second protrusion, and the second primary decorative cover is detachably connected to the second end cover via the second protrusion and the second recess, wherein the door body assembly further comprises:
a first secondary decorative cover detachably provided at the first end cover to shield the slide door mechanism and the first driven guide rail mechanism; and
a second secondary decorative cover detachably provided at the second end cover to shield the second driven guide rail mechanism, wherein one of the first secondary decorative cover and the first end cover is provided with the first protrusion, and other one is provided with the first recess corresponding to the first protrusion, and the first secondary decorative cover is detachably connected to the first end cover via the first protrusion and the first recess; and
one of the second secondary decorative cover and the second end cover is provided with the second protrusion, and other one is provided with the second recess corresponding to the second protrusion, and the second secondary decorative cover is detachably connected to the second end cover via the second protrusion and the second recess, wherein at least one of the first end cover, the second end cover, the first secondary decorative cover and the second secondary decorative cover is provided with a hand grip slot for opening or closing the box door.

20-22. (canceled)

23. The door body assembly of claim 13, wherein a first hook is provided at top of the door panel, and a second hook is provided at bottom of the door panel, and a length of the second hook is greater than a length of the first hook, and the first hook and the second hook are configured to be inserted into corresponding slots.

24. A refrigeration device, comprising:
a box body being formed with a storage space; and
the door body assembly of claim 10, the box door being rotatably connected to the box body and configured to open or close the storage space.

25. The refrigeration device of claim 24, wherein the box body is formed with at least two storage spaces, and the door body assemblies are provided in plural, each of the door body assemblies corresponds to one of the storage spaces, to drive the door panel to move relative to any box door during a process of opening or closing corresponding box door.

26. The refrigeration device of claim 25, wherein the box body is formed with a first storage space and a second storage space, and two door body assemblies are provided, that is a first door body assembly and a second door body assembly; and
a box door of the first door body assembly is rotatably connected to the box body and configured to open or close the first storage space, a box door of the second door body assembly is rotatably connected to the box body and configured to open or close the second storage space.
